(19) United States
(12) Patent Application Publication
(10) Pub. No.: US 2004/0077331 A1
(43) Pub. Date: Apr. 22, 2004

(54) System and method for tracking dropped calls in a wireless telecommunication system

(76) Inventor: Kevin H. King, Acworth, GA (US)

Correspondence Address: CINGULAR WIRELESS, 5565 GLENRIDGE CONNECTOR, 9TH FLOOR MC 920, C/O LINDA GILES, SYSTEM ANALYST, ATLANTA, GA, 30342, US

(21) Appl. No.: 10/273,037

(22) Filed: Oct. 17, 2002

(51) Int. Cl. H04Q 7/20

(52) U.S. Cl. 455/405; 455/403

(57) ABSTRACT

Tracking dropped calls in a wireless telecommunication system. A dropped call database is queried. The dropped call database comprises at least one dropped call record, the dropped call record having been created upon detection of a dropped call. The dropped call record corresponds to a dropped call and comprises fields of at least a mobile identification number associated with the dropped call and a time associated with the dropped call. The query is based on the mobile identification number. The method receives at least one field of the dropped call record returned based on the query and presents the at least one field of the dropped call record to a user.

### FIELD OF THE INVENTION

The invention relates generally to systems and methods for tracking dropped calls in a wireless telecommunication system, and more particularly, to systems and methods for tracking dropped calls in a wireless telecommunication system using a switches database.

### BACKGROUND OF THE INVENTION

The use of telephone products and systems in the day-to-day lives of most people is continually growing. In an effort to lower operating costs and increase value for its subscribers, wireless telecommunication providers wish to track dropped calls in the wireless telecommunication system. Dropped calls are wireless calls that are broken prior to either party to the call initiating a disconnect. Wireless telecommunication system providers may attract new subscribers to the wireless telecommunication system or may tend to retain current subscribers by tracking and resolving dropped calls. Thus, wireless telecommunication system providers may realize a competitive advantage by tracking and solving dropped calls.

Therefore, the need to efficiently track dropped calls in a wireless telecommunication system has become a common need for many wireless telecommunication providers. More specifically, tracking network problems in a wireless telecommunication system using and databases associated with a switch has become a critical service for many wireless telecommunication providers. This is because in an increasingly competitive environment, meeting and exceeding the expectations of subscribers or others who receive services is essential for a wireless telecommunication provider.

Additionally, customer service frequently receives calls from subscribers complaining about dropped calls. With no ability to track dropped calls, customer service may merely credit the subscriber in an effort to maintain positive customer relations. Unfortunately, the inability in prior art systems to track dropped calls from a customer service vantage was rife with opportunities for abuse. Unscrupulous subscribers could be credited for calls that were never dropped. While prior art systems enabled occasional statistical data to be generated providing a list of the top subscribers receiving credit for dropped calls, there was no means available to review dropped call information on demand.

Thus, there remains a need to efficiently track dropped calls in a wireless telecommunication system. In addition, there remains a need for tracking dropped calls in a wireless telecommunication system using a database switch.

### SUMMARY OF THE INVENTION

Consistent with the present invention, methods and systems for tracking dropped calls in a wireless telecommunication system are provided that avoid problems associated with prior methods and systems for tracking dropped calls in a wireless telecommunication system as discussed herein above.

In one aspect, a method for tracking dropped calls in a wireless telecommunication system is disclosed. A dropped call database is queried. The dropped call database comprises at least one dropped call record, the dropped call record having been created upon detection of a dropped call. The dropped call record corresponds to a dropped call and comprises fields of at least a mobile identification number associated with the dropped call and a time associated with the dropped call. The query is based on the mobile identification number. The method receives at least one field of the dropped call record returned based on the query and presents the at least one field of the dropped call record to a user.

In another aspect, a system for tracking dropped calls in a wireless telecommunications system is disclosed. The system comprises a dropped call database server and a dropped call database client. The dropped call database server comprises a dropped call database comprising at least one dropped call record, the dropped call record having been created upon detection of a dropped call, the dropped call record corresponding to a dropped call and comprising fields of at least a mobile identification number associated with the dropped call and a time associated with the dropped call. The dropped call database client is adapted to: receive a query from a user comprising a mobile identification number; query the dropped call database server for dropped call records based on the mobile identification number; and present at least one field from the returned dropped call database records to the user.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a functional block diagram of an exemplary system for tracking dropped calls in a wireless telecommunication system consistent with an embodiment of the present invention;

FIG. 2 illustrate a dropped call database in accordance with the principles of the present invention;

FIG. 3 illustrates an exemplary query screen for producing a dropped call report according to the principles of the present invention;

FIG. 4 illustrates an exemplary dropped call report screen according to the principles of the present invention; and

FIG. 5 illustrates a flowchart of a method for generating a dropped call report according to the principles of the present invention.

### DESCRIPTION OF THE EMBODIMENTS

Reference will now be made to various embodiments according to this invention, examples of which are shown in the accompanying drawings and will be obvious from the description of the invention. In the drawings, the same reference numbers represent the same or similar elements in the different drawings whenever possible.

Consistent with the general principles of the present invention,, a system for tracking dropped calls in a wireless telecommunication system comprises a component for creating a dropped call record in a dropped call database after the dropped call is detected, the dropped call record corresponding to the problem, and a component for querying the dropped call database in operating the wireless telecommunication system.

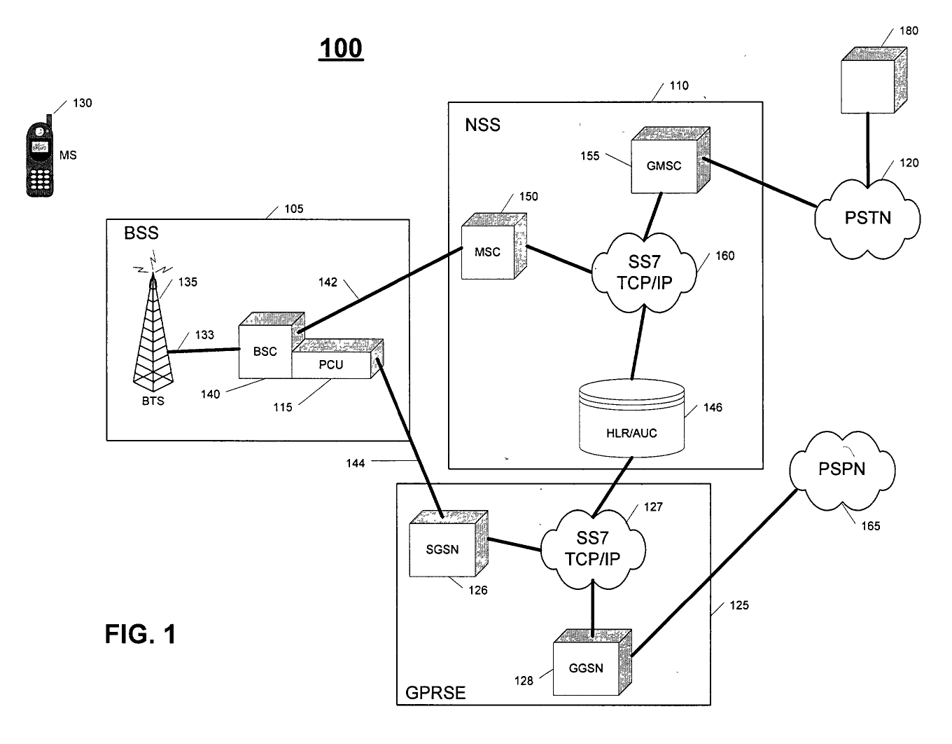

As herein embodied and illustrated in FIG. 1, a wireless telecommunication system 100 may comprise a base station subsystem (BSS) 105, a network and switching subsystem (NSS) 110, a mobile station (MS) 130, a publicly switched telephone network (PSTN) 120, and a publicly switched packet network (PSPN) 165. The elements of system 100 will be described in greater detail below.

System 100 may utilize a global system for mobile communications (GSM), technology enhanced with general packet radio service (GPRS) in embodiments of the present invention. GSM, developed in the 1980s and predominantly used in Europe, operates in the 900 MHz and 1.8 GHz bands in Europe and the 1.9 GHz PCS band in the U.S. GSM phones may use a subscriber identity module (SIM) smart card that contains user account information. GSM phones are automatically programmed by plugging in the SIM card, allowing GSM phones to be used interchangeably in situations such as renting or borrowing. In addition, GSM may include a short messaging service (SMS) that enables text messages up to 160 characters in length to be exchanged. GSM supports data transfer rates of 9.6 Kbps to packet networks.

GPRS is an enhancement for GSM that supports packetized data. GPRS enables a continuous flow of Internet Protocol data packets over the telecommunication system for applications such as Web browsing and file transfer. GPRS differs from SMS because SMS is limited to messages of 160 bytes in length, GPRS has no such limit. Additionally, those skilled in the art will appreciate that EDGE is an enhancement to the GSM and TDMA wireless telecommunication systems that increases data throughput.

Those of ordinary skill in the art will appreciate that other wireless telecommunication technology standards, in addition to GSM and GPRS, may be employed, for example, FDMA, TDMA, CDMA, CDMA2000, UTMS, and EDGE, without departing from the spirit of the invention.

Wireless telecommunications may include radio transmission via the airwaves, however, those of ordinary skill in the art will appreciate that various other telecommunication techniques can be used to provide wireless transmission including infrared line of sight, cellular, microwave, satellite, blue-tooth packet radio, and spread spectrum radio. Wireless data may include, but is not limited to, paging, text messaging, e-mail, Internet access, instant messaging, and other specialized data applications specifically excluding or including voice transmission.

As shown in FIG. 1, BSS 105 may comprise, for example, a base station controller (BSC) 140, a base transceiver station (BTS) 135, and a packet control unit (PCU) 115. BSS 105 connects to MS 130 through a radio interface and connects to NSS 110 through an interface 142. BSC 140 controls BTS 135 and may control a plurality of other base transceiver stations in addition to BTS 135. BTS 135 may comprise radio transmission and reception equipment located at an antenna site. Associated with BSS 105, a transcoder/rate adaptation unit (TRAU) (not shown) may perform speech encoding, speech decoding and rate adaptation for transmitting data. As a subpart of BTS 135, the TRAU may be located away from BTS 135, for example, at a mobile switching center located in NSS 110. When the TRAU is located in this way, the low transmission rate of speech code channels allows more compressed transmission between BTS 135 and the TRAU.

PCU 130 connects BSS 105 to GPRSE 125, which allows, for example, the Internet to link with MS 130. PCU 115 adds level 2 functions of GPRS such as data aware radio link control (RLC) and the MAC protocol layer as well as performing radio resource configuration and channel assignment.

GSM systems may use anopen system interconnection (OSI). There are several common interfaces defined by OSI such as a common radio interface (referred to as air interface) used between MS 130 and BTS 135, and an A-bis interface 133 used between BTS 135 and BSC 140. With common interfaces such as those defined by OSI, a telecommunication system operator can utilize and interchange equipment of various manufactures when implementing communication systems. The difference between interface and protocol is that an interface represents the point of contact between two adjacent entities (equipment or systems) and a protocol provides information that flows through the interface. For example, the GSM radio interface is the transit point for information flow pertaining to several protocols. Also, interface 142 between NSS 110 and BSS 105 may comprise T-1 lines using X.25 or TCP/IP protocol.

MS 130 may comprise a mobile phone, a personal computer, a hand-held computing device, a multiprocessor system, a microprocessor-based or programmable consumer electronic device, a minicomputer, a mainframe computer, a personal digital assistant (PDA), a facsimile machine, a telephone, a pager, a portable computer, or any other device for receiving and/or transmitting information. MS 130 may utilize cellular telephone protocols such as wireless application protocol (WAP). Such mobile systems may also be configured to permit the user to purchase products through a browser on a display of the mobile device. The invention, as disclosed in this embodiment, in its broadest sense is not limited to a particular form of mobile system or communication protocol. And those of ordinary skill in the art will recognize that other systems and components may be utilized within the scope and spirit of the invention.

MS 130 may be a stand-alone piece of equipment for certain services or support the connection of external terminals, such as the interface for a personal computer or facsimile machine. MS 130 may include mobile equipment (ME) (not shown) or a subscriber identity module (SIM). The ME does not need to be personally assigned to one subscriber. GSM phones, for example, may use a SIM card that contains subscriber account information, as GSM phones may be automatically programmed by plugging in the SIM card. This allows GSM phones to be used interchangeably in situations such as renting or borrowing. When a subscriber's SIM is inserted into the ME of MS 130, all calls for the subscriber are delivered to MS 130. Thus, the ME is not associated with a particular number, but rather, is linked to the subscriber's SIM.

In addition, GSM systems may include a short messaging service (SMS) that enables text messages up to 160 characters in length to be exchanged. SMS is a text messaging service that enables short messages of generally no more than 140-160 characters in length to be sent and transmitted from mobile stations. SMS was first introduced in the GSM system and later supported by other digital-based mobile communication systems. Unlike paging, short messages are stored and forwarded in SMS centers. SMS messages travel to mobile stations over the wireless telecommunication system's control channels, which are separate and apart from voice channels.

Still referring to FIG.1, NSS 110 may comprise a mobile switching center (MSC) 150, a first network 160, a home location register/authentication center (HLR/AUC) 146, and a gateway mobile switching center (GMSC) 155. NSS 110 manages the communication between subscribers. Such as, an operator using MS 130, and other telecommunication users, or those using publicly switched telephone network (PSTN) 120. PSTN 120 may comprise, for example, the worldwide voice telephone network.

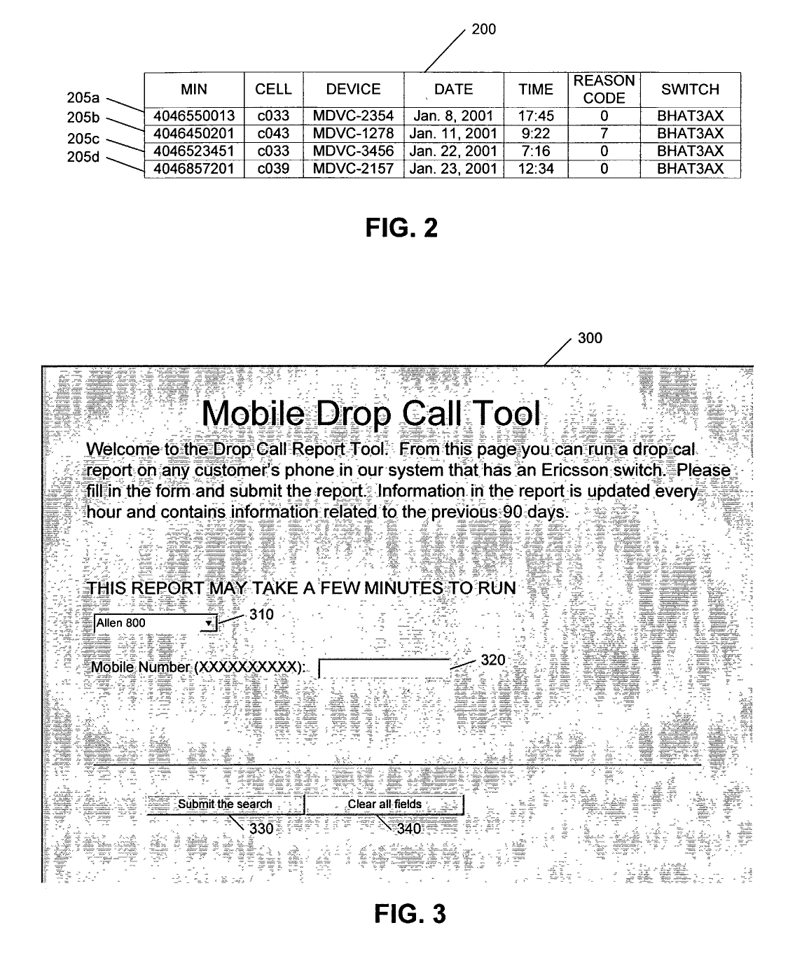

MSC 150 coordinates call set-up to and from subscribers using MS 130. MSC 150 may control several base station controllers such as, and similar to BSC 140. MSC 150 may also comprise a dropped call database for maintaining a record of dropped calls from each associated BSC 140. The dropped call database may comprise an SQL database on an SQL Server. The dropped call database of MSC 150 is further illustrated in FIG. 2.

GMSC 155 is used to interface with external networks for communication with users outside of the wireless system, such users on PSTN 120.

HLR/AUC 146 may comprise a stand-alone computer without switching capabilities, a database that contains subscriber information, and information related to the subscriber's current location, but not the actual location of the subscriber. The AUC portion of HLR/AUC 146 manages the security data for subscriber authentication. Another sub-division of HLR/AUC 146 may include an equipment identity register (EIR) (not shown) that may store data relating to mobile equipment (ME).

NSS 110 may also include a visitor location register (VLR) (not shown). The VLR links to one or more mobile switching centers located on other systems, temporarily storing subscription data of subscribers currently served by MSC 150. The VLR holds more detailed data than HLR/AUC 146. For example, the VLR may hold more current subscriber location information than the location information at HLR/AUC 2301.

GMSC 155 is utilized to interface with PSTN 120. In order to set up a requested call, the call is initially routed to GMSC 155 that finds the correct home location register by knowing the director number of the subscriber. GMSC 155 has an interface with an external network, such as PSTN 120, for providing gateway communications.

The elements of NSS 110 are connected using first network 160. First network 160 may comprise an intelligent network utilizing signal system 7 (SS7) in an ISDN user part (ISUP) protocol. SS7 is a global standard for telecommunications defined by the Telecommunication Standardization Sector of the International Telecommunication Union. The SS7 standard defines the procedures and protocol by which network elements in a public switched telephone network exchange information over a digital signaling network to effect wireless and wireline call setup, routing, and control. ISUP defines the protocol and procedures used to set-up, manage, and release trunk circuits that carry voice and data calls over a public switched telephone network. ISUP is used for both ISDN and non-ISDN calls. Calls that originate and terminate at the same switch do not use ISUP signaling.

As shown in FIG. 1, GPRSE 125 may comprise a serving GPRS service node (SGSN) 126, a second network 127, and a gateway GPRS service node (GGSN) 128. In order to implement GPRS, two new node types may be added to a conventional GSM network, GGSN 128 and SGSN 126. Also, the interfaces to the conventional GSM system may be augmented and an extra unit, such as PCU 115 that may be located in BSS 105 as described above, may be added.

SGSN 126 connects GPRSE 125 to BSS 105 through interface 144, which may comprise T-1 lines using X.25 or TCP/IP protocol, for example. SGSN 126 receives the traffic from mobile subscribers associated with BSS 105 and forwards the traffic to GGSN 128. SGSN 126 uses its links with HLR/AUC 146 to authenticate and bill subscribers, and may provide additional services such as data compression, session management and encryption.

GGSN 128 acts as a gateway to PSPN 165, which is most often a publicly switched packet network such as the Internet. Data is sent across the GPRS network to GGSN 128, un-encapsulated, and then forwarded to the next node. To the outside world GGSN 128 may appear as just another router on the Internet. Common features of GGSN 128 may include firewall/packet-filtering technologies and a dynamic host configuration protocol (DHCP) server to configure IP options of MS 130 as it logs onto the network. DHCP automatically assigns IP addresses to client stations logging onto a TCP/IP network. It eliminates having to manually assign permanent IP addresses. DHCP software typically runs in servers and is also found in network devices such as ISDN routers and modem routers that allow multiple users access to the Internet.

SGSN 126 and GGSN 128 are connected through second network 127. Second network 127 may employ SS7 as described above and use transmission control protocol/internet protocol (TCP/IP).

PSPN 165 may be accessed by MS 130 through GPRSE 125 in a conventional manner as is know by those of ordinary skill in the art. Likewise, PSTN 120 may be accessed by MS 130 through NSS 110 in a conventional manner as is know by those of ordinary skill in the art.

Customer Service PC (CSP) 180 may be connected to the NSS 110 through the PSTN 120. Alternatively, CSP 180 may interface to the NSS 110 through the PSPN 165. In another embodiment, CSP 180 may interface through SS7 ISUP 160 into the NSS 110. CSP 180 operates as a client node to interrogate the dropped call database maintained on MSC 150. Those skilled in the art will appreciate that multiple NSS 110 may exist throughout a telecommunications providers system, so that CSP 180 may communicate to any of a number of MSC 150 within a number of NSS 110.

FIG. 2 illustrates a dropped call database 200 in accordance with the principles of the present invention. Dropped call database (DCD) 200 may be stored as a SQL Server database on an MSC. In alternative embodiments the DCD 200 may be stored in a database that acquires the dropped call information from a switch, such as MSC 150, but the database is located remotely from the switch. The DCD 200 may comprise one or more dropped call records 205a-d. Each dropped call record 205a-d may contain dropped call information for each particular instance of a dropped call. Such dropped call information may include one or more of the following: the mobile identification number (“MIN”), the cell site identifier, the device identifier, the date, the time, a reason code, and/or a switch identifier. Those skilled in the art will appreciate that other dropped call information may also be stored.

Examining dropped call record 205a for illustrative purposes, the record shows that the mobile station identified by 4046550013 (generally the phone number of the mobile station) experienced a dropped call. The dropped call occurred at cell site c033 on device MDVC-2354. It occurred at 5:45 p.m. on Jan. 8, 2001. The reason the call was dropped was a reason code “0”. Each switch may have one or more reason codes that it associates with a dropped call. Reason code “0” may correspond, for example, to a “call start failure.” The switch reporting the dropped call was switch BHAT3AX.

In an exemplary embodiment of the present invention, the following reason codes are used (as illustrated in the table below). These reason codes correspond to the reason codes for a switch manufactured by Ericsson.

| | |
|---|---|
| 0 | Call start failure |
| 1 | Internal handoff failure |
| 2 | Interexchange handoff to cooperating exchange failure |
| 3 | Interexchange handoff from cooperating exchange |
| | failure |
| 4 | Interexchange handoff to third-party exchange failure |
| 5 | Forced release |
| 6 | Technical Fault |
| 7 | Insufficient transmission quality |
| 9 | Abnormal call termination |
| 10 | Forced release due to out of cell |

The optional use of reason codes facilitates supplying more detailed information to not only customer service representatives, but also technicians whom the customer service representatives may contact.

FIG. 3 illustrates an exemplary query screen for producing a dropped call report according to the principles of the present invention. The dropped call query screen 300 may be generated through a PERL script or any other coding form. A customer service representative operating on CSP 180 may request a dropped call report utilizing dropped call query screen 300. Typically, the customer service representative may perform such a query when a subscriber complains about dropped call issues with their service. In this way, the customer service representative can check the validity of the complaint and promptly take action to possibly credit the subscriber's account. The customer service representative may select a switch for query in switch input 310. In mobile identification number input 320, the customer service representative may input the subscribers mobile identification number. If the input items are acceptable, the customer service representative may hit submit button 330 to submit the query, or, if the input items are unacceptable, the customer service representative may hit clear button 340. Once the submit button is hit, a database query, e.g. in an SQL database an SQL query, is generated.

The query is run on the appropriate dropped call database based on the switch selected for query in switch input 310. Once the query is complete, a dropped call report is generated.

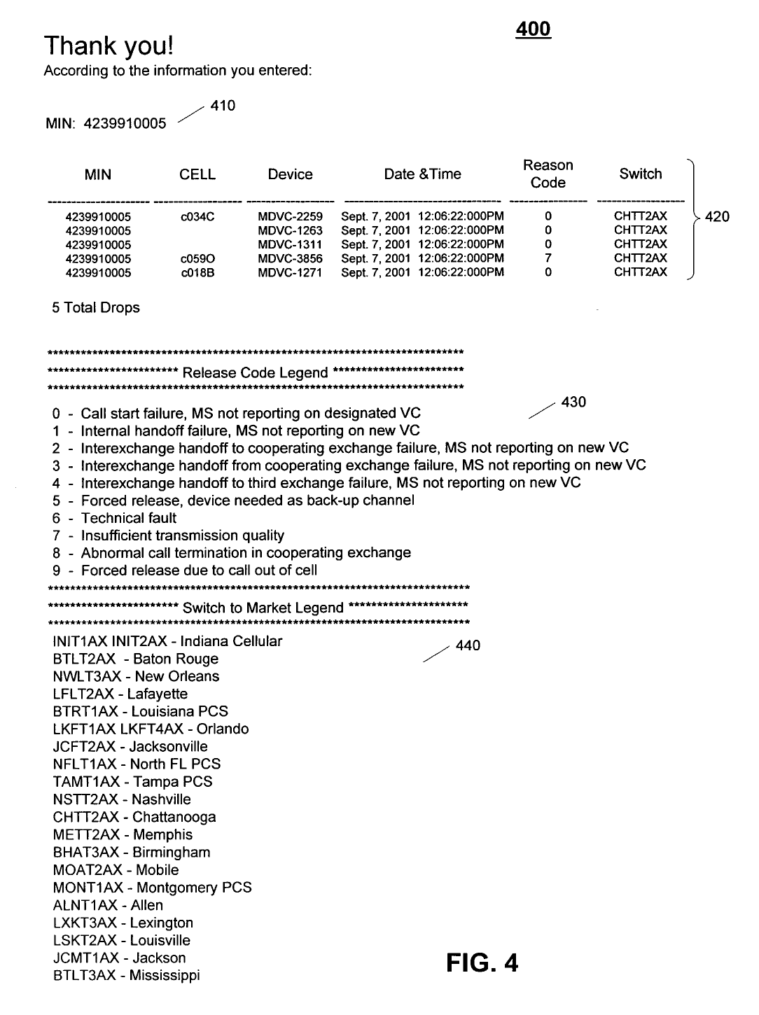

FIG. 4 illustrates an exemplary dropped call report screen according to the principles of the present invention. Generated in response to a query, the dropped call report screen lists all dropped call for a queried mobile identification number. The dropped call report may be limited to a particular time period, for instance the last ninety days. The dropped call report may contain an identification of the subscriber's MIN for which the query is performed (410). The listing of dropped calls 420 may be provided. The listing 420 may contain all or a portion of the dropped call information contained in the dropped call records. A release code legend 430 may be provided to assist the customer service representative, or a later contacted technician, in understanding the reasons for the dropped calls. In addition, a switch to market legend 440 may be provided to assist the customer service representative in decoding the listing of dropped calls 420.

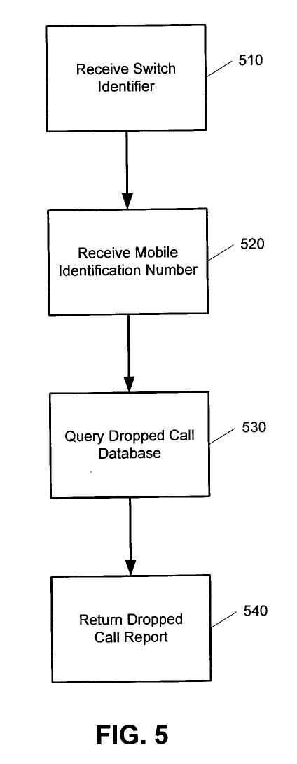

FIG. 5 illustrates a flowchart of a method of generating a dropped call report according to the principles of the present invention. At stage 510, the customer service representative enters a switch identifier. If the customer service representative does not know the switch identifier, she may leave not enter this input and the system will determine the appropriate switch based on the MIN of the subscriber. At stage 520, the customer service representative enters the mobile identification number of the subscriber, typically the subscriber's mobile station number. At stage 530, a database query is generated and run by the client on the database server containing the dropped call database associated with the mobile station number. The database query will return all dropped calls over a time period. The time period can be configured by the system programmer, or optionally entered by the customer service representative. At stage 540, a dropped call report is returned by the system for viewing by the customer service representative.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements which may be connected directly to the system or which may transfer the information to the system over a network or other mechanism for transferring information in a conventional manner.

The foregoing description has been limited to a specific embodiment of this invention. It will be apparent, however, that various variations and modifications may be made to the invention, with the attainment of some or all of the advantages of the invention. It is the object of the appended claims to cover these and such other variations and modifications as come within the true spirit and scope of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for tracking dropped calls in a wireless telecommunication system, comprising:
querying a dropped call database comprising at least one dropped call record, the dropped call record having been created upon detection of a dropped call, the dropped call record corresponding to a dropped call and comprising fields of at least a mobile identification number associated with the dropped call and a time associated with the dropped call, wherein the query is based on the mobile identification number;
receiving at least one field of the dropped call record returned based on the query; and
presenting the at least one field of the dropped call record to a user.

2. The method of claim 1 wherein the dropped call record further comprises a reason code field and the reason code field is received and presented to the user.

3. The method of claim 1 wherein the dropped call record further comprises a date field and the date field is received and presented to the user.

4. The method of claim 1 wherein the dropped call record further comprises a switch field and the switch field is received and presented to the user.

5. The method of claim 1 wherein the dropped call record further comprises a cell field and the cell field is received and presented to the user.

6. The method of claim 1, wherein the dropped call database query is limited to returning dropped call records generated over a fixed period of time.

7. The method of claim 6 wherein the period of time is predetermined.

8. The method of claim 6 wherein the period of time is input to the query by the user.

9. A system for tracking dropped call in a wireless telecommunications system, the system comprising:
a dropped call database server comprising a dropped call database comprising at least one dropped call record, the dropped call record having been created upon detection of a dropped call, the dropped call record corresponding to a dropped call and comprising fields of at least a mobile identification number associated with the dropped call and a time associated with the dropped call; and
a dropped call database client, the dropped call database client adapted to:
receive a query from a user comprising a mobile identification number;
query the dropped call database server for dropped call records based on the mobile identification number; and
present at least one field from the returned dropped call database records to the user.

10. The system of claim 9 wherein the dropped call database server is stored on a switch.

11. The system of claim 9 wherein the dropped call database server is remote from a switch and received dropped call records from the switch for storage.
